(19) United States
(12) Patent Application Publication
(10) Pub. No.: US 2009/0230241 A1
(43) Pub. Date: Sep. 17, 2009

(54) Device for Fastening an Object

(76) Inventors: Christian Heller, Aach (DE); Ulrich Papenburg, Munchen (DE)

Correspondence Address: LAMBERT & ASSOCIATES, P.L.L.C., 92 STATE STREET, BOSTON, MA, 02109-2004, US

(21) Appl. No.: 12/227,336

(22) PCT Filed: May 16, 2007
(86) PCT No.: PCT/EP2007/004381

§ 371 Date: Nov. 14, 2008

(30) Foreign Application Priority Data
May 16, 2006 (DE) 20 2206 007 845.2

(51) Int. Cl. B64C 1/20

(52) U.S. Cl. 244/118.1

(57) ABSTRACT

The invention relates to a device for immobilizing an object on an anchor point, a rail or the like, inside a space, especially a cargo hold or passenger compartment of a helicopter. According to the invention, a detachable connecting element is interposed between the anchor point or the rail and the object.

The present invention relates to a device for fastening an object at a lashing point, a rail or the like, inside a space, in particular a cargo hold or a passenger compartment of a helicopter.

### BACKGROUND ART

Such devices exist in a variety of shapes and designs and are commonly used. Thus, for example, DE 20 2004 007 781 U1 describes a fastening device for insert plates, in particular protective linings or ballast plates, inter alia, in helicopters. In this case the fastening device comprising insert parts and/or protective linings comprises additional fastening rails, which are provided with locking elements, which fit into the first original fastening rail.

The drawback with this fastening device is that the two fastening rails are connected to each other in an unwieldy and complicated way. Thus, both the first and the second fastening rails exhibit components for interlocking the two fastening rails. The individual components have to be brought first into alignment with each other by complicated means before the second fastening rail can be mounted on the original fastening rail. This procedure is not easy to carry out and is time consuming.

### Problem

The object of the present invention is to provide a device, which is intended for fastening an object and which eliminates the aforementioned drawbacks. Moreover, the device reliably guarantees the fastening of an object and can be simultaneously accessed at any time, so that it is possible to detach the object. Moreover, it is possible, especially in the case of military helicopters, to secure, for example, so-called ceramic Kevlar plates without limiting the ability to access the devices for fastening an object.

### Solution of the Problem

This object is achieved in that a detachable connecting element is interposed between the lashing point and/or the rail and the object.

In order to be able to fasten first the connecting element at the lashing point, the connecting element exhibits a base plate with a recess, which runs in the longitudinal direction in said base plate, in which are inserted bolts, in order to be able to mount a guide rail on an underside of the base plate. This guide rail can be detached again or be securely fastened on the underside. That is, the bolts can be disposed, for example, by means of a thread in a rail track of the guide rail or can be welded securely to said rail track.

The guide rail is inserted into a matching longitudinal groove in a surface of a base plate of the lashing point. To this end, a raised rim area of the longitudinal groove exhibits circular recesses, into which can be inserted the wings on the rail track of the guide rail, because said wings are designed so as to be identical in shape to the circular recesses, but yet are slightly smaller. At the same time a bridge section between the wings is designed so as to be identical in shape to a spacer between the circular recesses of the longitudinal groove, but yet is slightly smaller. Therefore, it is possible to recess the guide rail in the longitudinal groove.

Furthermore, the rim area projects at least partially beyond the longitudinal groove, so that both sides of the longitudinal groove exhibit an undercut area, in which the wings of the guide rail can traverse, because the wings are slightly narrower than these undercut areas.

So that the guide rail and, thus, the connecting element cannot slide out of the longitudinal groove, the bridge section between the wings forms a bridge over a recess in the base plate owing to a material recess. When viewed from the bottom, the recess exhibits a rectangular borehole component, where the two sides of the borehole component are rounded off. When viewed from the top, the recess exhibits a totally circular borehole component. Both borehole components are separated from each other by a step.

A fastening element, which is connected securely or detachably to the bridge section on one side, runs through the recess. In the case under discussion the fastening element was disposed by means of a threaded section in a threaded borehole, which is provided for this purpose in the bridge section. However, it is conceivable to weld or the like the fastening element, for example, securely to the bridge section.

The other end of the fastening element exhibits a rotating knob on a shaft section. This rotating knob exhibits an upper, totally circular section, conforming with the circular borehole component. In contrast, a bottom section of the rotating knob conforms in its shape with the rectangular borehole component, which is rounded off on two opposite sides.

Mounted on a top side of the upper section of the rotating knob is a direction indicator, which is arranged in parallel to the bottom section and, thus, can reproduce the position of the bottom section, when the rotating knob is viewed from the top.

In particular, the rotating knob serves to fasten the connecting element at the lashing point. To this end, the rotating knob is mounted in a displaceable manner on the fastening element or rather the shaft section. Therefore, a recess, through which the shaft section of the fastening element runs, extends approximately through the middle of the rotating knob. A spring is provided around the shaft section. One side of this spring is braced against the underside of a screw head of the fastening element. On the opposite side the spring is braced against the bottom floor of the bottom section.

In the starting position—that is, in the unlocked state—when, therefore, the connecting element is not yet connected to the lashing point, the rotating knob is located in a position, in which its bottom section runs parallel to the recess in the base plate of the connecting element and, thus, rests with its end side on the step, formed by the two borehole components, in the recess. The upper section is located above the plane of the recess. The spring around the shaft section is compressed between the underside of the screw head and the bottom floor of the bottom section.

If then the connecting element has been inserted into the lashing point, as already described multiple times, and is to be locked there, the rotating knob is rotated until its bottom section moves totally into the open area of the rectangular borehole component.

At this point the spring, which has been under tension until now, can be relaxed and pushes downwards by way of the floor of the bottom section the rotating knob on the shaft section in the recess.

In this way the top side of the rotating knob moves into the plane of the recess, the bottom section of the rotating knob fills the cavity below the bridge section and simultaneously one of the circular recesses in the rim area of the longitudinal groove. At the same time the wings of the guide rail are located in the undercut areas adjacent to the circular recesses of the longitudinal groove. At this point it is no longer possible to remove the connecting element from the lashing point and/or to displace the connecting element in the lashing point.

However, the rotating knob does not have to be necessarily rotated; instead, it may suffice to raise the rotating knob above the rim area of the lashing point. In this state the connecting element continues to be displaced until the top side of the rotating knob moves into the plane of the recess, and the rotating knob automatically locks downwards. Then the sequence of events that have already been described above takes place. At this point it is no longer possible to remove the connecting element from the lashing point and/or to displace the connecting element in the lashing point.

Both sides of the recess in the base plate of the connecting element are hemmed in the longitudinal direction by strips, which project partially beyond the recess. The result is that in this case, too, undercut sliding channel areas are formed, and the cross section of the recess assumes the shape of an upside down T. The sliding channel areas serve to accommodate and/or to move an object that is to be inserted into the recess.

The strips in turn are also provided with circular recesses, in which an object, which is not illustrated in detail, can be fastened, for example, in a way analogous to the connecting element in the lashing point.

It is possible to provide along the recess and/or the strips the threaded boreholes, which are configured uniformly in the base plate and which are used to fasten ceramic Kevlar plates (not illustrated in detail) or the like. Such ceramic Kevlar plates are used as ballistic protection for the occupants of, for example, a helicopter or the like and have to be securely anchored on the floor. This anchoring is done with the aid of the threaded boreholes in the base plate of the connecting element or by adhesive cementing. At the same time it is guaranteed that additional objects can be fastened in the connecting element. That is, despite the attachment of the ceramic Kevlar plates, the connecting element remains freely accessible.

The embodiment under discussion was designed so that both the rim area of the longitudinal groove of the lashing point and the strips of the connecting element are configured with two respective circular recesses. However, the present invention shall include the option of also providing only one circular recess or more than two circular recesses. Usually this number depends on the type of application.

Furthermore, the guide rail was also provided with two wings on each side of the rail track. In this case, too, it is conceivable that only one wing or more than two wings is/are provided on each side of the rail track. Furthermore, there is the possibility of dispensing with a connection of the wings, so that these wings can be fastened individually to a single rail track on the underside of the base plate of the connecting element. Then, however, there must exist the option of fastening by a different method the fastening element, on which the rotating knob is mounted. In this case, for example, it is possible to provide a separate bridge piece, which is mounted in parallel or orthogonally to the rail tracks. However, it is also possible to continue to connect together the two rail tracks by means of a bridge section, to which then the fastening element is fastened. Then, additional wings and/or rail tracks can also be connected either individually or all of them together by means of such bridge sections.

The various possibilities with respect to the number, design and arrangement of the guide rail and/or the rail tracks and the wings individually or in combination shall be included in the present invention. The important factor is that there is a possibility of arranging the fastening element and with it the rotating knob in such a manner that the result is a simple and easy way of fastening the connecting element to the lashing point.

Instead of the fastening element, at which the rotating knob can be moved in a spring loaded manner, it is also possible to provide any type of system that guarantees that the rotating knob will move from an unlocking position into a locking position. These possibilities shall also be included in the present invention.

In summary it should also be mentioned that, instead of the circular recesses and the wings, the round rotating knob and the round shapes of the recess, any other shape is conceivable and shall be included in the present invention. Therefore, it is quite conceivable to replace the round shapes with angular, oval or similar shapes. In this respect the only feature that must be guaranteed is the continued existence of the interaction of the individual components (that has been repeatedly described above), said interaction being also obvious on account of the shape.

The present invention provides a device for fastening an object. This device makes it possible, on the one hand, to fasten the aforementioned ceramic Kevlar plates or the like to the connecting element and simultaneously, on the other hand, to have the option of fastening additional objects to or in the connecting element. That is, despite the attachment of the ceramic Kevlar plates, there is still access to the connecting element.

### DESCRIPTION OF THE FIGURES

Other advantages, features and details of the present invention are disclosed in the following description of preferred embodiments with reference to the drawings.

FIG. 1 is a perspective, enlarged view of a device, which is intended for fastening an object and comprises a lashing point and a connecting element, according to the present invention.

FIG. 2 is a cross-sectional view of the lashing point in FIG. 1 and the connecting element in FIG. 4 along the line II-II.

FIG. 3 is a top view of the connecting element in FIG. 1 in the locked state.

FIG. 4 is a bottom view of the connecting element in FIG. 1 in the locked state.

FIG. 5 is a longitudinal view of the connecting element in FIG. 3 along the line V-V.

FIG. 6 is a top view of the connecting element in FIG. 1 in the unlocked state; and

FIG. 7 is a bottom view of the connecting element in FIG. 1 in the unlocked state.

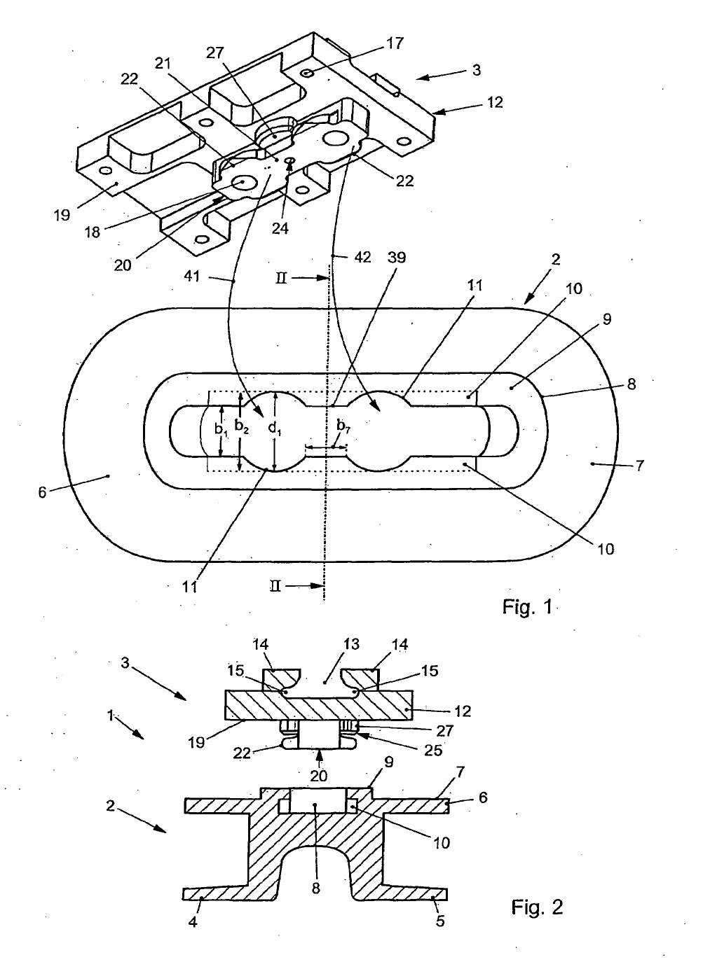

FIGS. 1 and 2 depict a device 1, which is intended for fastening an object (not illustrated in detail) and which comprises a lashing point 2 and a connecting element 3.

The lashing point 2 is preferably a milled part made of aluminum and exhibits at least two rail arms 4 and 5, with which the lashing point 2 can be fastened, for example, on a floor (not illustrated in detail) of a helicopter. The rail arms 4 and 5 are connected preferably as one piece to a base plate 6.

On the side of the base plate 6 that lies opposite the rail arms 4 and 5, this base plate exhibits a longitudinal groove 8, which runs on the surface 7 of said base plate. Around the longitudinal groove 8 extends a raised rim area 9. This rim area 9 covers at least partially the longitudinal groove 8 in the longitudinal direction, so that the sliding channels 10 are formed there. Only in the area of the circular recesses 11, cut into the rim area 9, is the longitudinal groove 8 not covered.

Therefore, a width b₁ of the longitudinal groove 8 is less than a width b₂ between the sliding channels 10. A diameter d₁ of the circular recesses 11 in turn is approximately as large as the width b₂ between the sliding channels 10.

The connecting element 3, which is shown in FIGS. 1 to 7, is also made preferably of aluminum and exhibits a base plate 12 with a recess 13, which runs in the longitudinal direction in said base plate. Both sides of the recess 13 are hemmed in the longitudinal direction by strips 14, which project partially beyond the recess 13 and in this way also form an undercut sliding channel area 15. On the whole, the result is that the cross section of the recess 13 has the shape of an inverted T, as shown in FIG. 2.

The strips 14 are also provided with circular recesses 16. Therefore, a diameter d₂ of the circular recesses 16 corresponds in essence to the width b₃ of the recess 13. A width b₄ between the strips 14 in turn is less than the width b₃ of the recess 13.

At the same time the diameter d₂ of the circular recesses 16 of the connecting element 3 corresponds in essence to the diameter d₁ of the circular recesses 11 of the lashing point 2. The width b₃ of the recess 13 of the connecting element 3 in turn corresponds to the width b₂ between the sliding channels 10 of the lashing point 2, and the width b₄ between the strips 14 of the connecting element 3 corresponds to approximately the width b₁ of the longitudinal groove 8 of the lashing point 2.

Furthermore, the base plate 12 can exhibit threaded boreholes 17, which are uniformly arranged along the recess 13 and/or the strips 14 and which are used to fasten, for example, ceramic Kevlar plates, which are not shown in detail.

The bolts 18 in the recess 13 are used to mount securely or detachably a guide rail 20 on an underside 19 of the base plate 12. This guide rail matches up to a certain extent the shape of the longitudinal groove 8, including the circular recesses 11, and/or matches the shape of the recess 13, including the circular recesses 16. The wings 22, which are formed as one piece on an approximately rectangular rail track 21, match the circular recesses 11 and/or 16.

Thus, a width b₅ of the rail track 21 is slightly less than the width b₄ between the strips 14 and the width b₁ of the longitudinal groove 8, and a diameter d₃ between the wings 22 is slightly less than the diameter d₂ of the circular recesses 16 and the diameter d₁ of the circular recesses 11 as well as the width b₃ of the recess 13 and the width b₂ between the sliding channels 10.

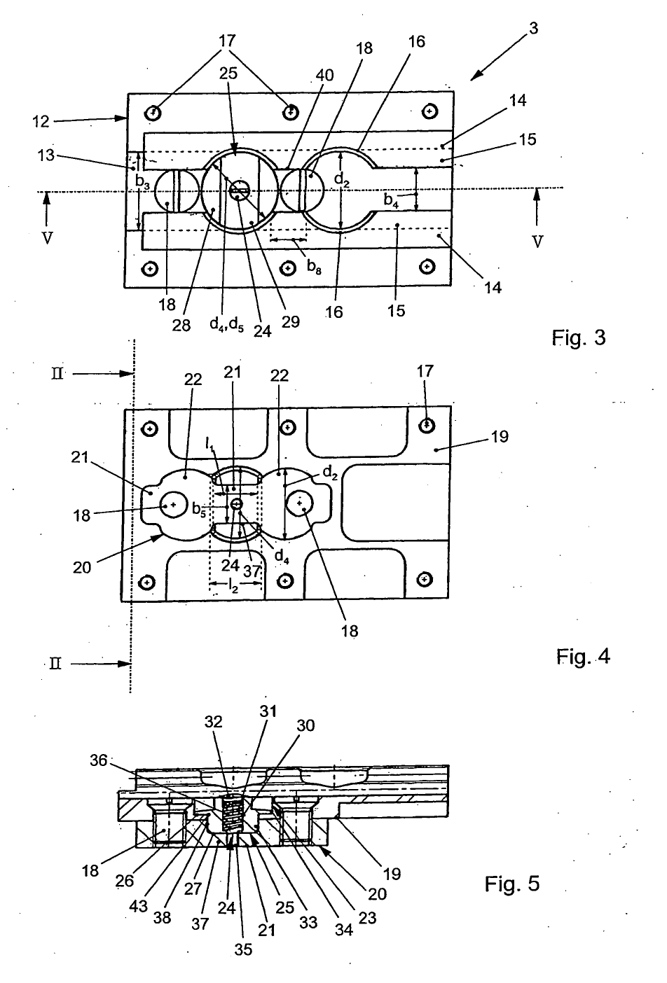

One section 37 of the rail track 21 between the wings 22 exhibits a material recess 38 and forms in this way a bridge over a recess 23 in the base plate 12, which is especially evident in FIG. 7. The recess 23 is formed as two steps and, when viewed from the bottom, exhibits a rectangular borehole component 33. In this case the two sides of the borehole component 33 are rounded off in the shape of a circle. When viewed from the top, it is obvious in FIG. 3 that the borehole component 34 has the shape of a complete circle.

In this case the length l₁ of the bridge section 37 corresponds to approximately a width b₆ of the straight sides of the rectangular borehole component 33 and a width b₇ of a spacer 39 between the circular recesses 11 of the lashing point 2 and a width b₈ of a spacer 40 between the circular recesses 16 of the connecting element 3.

Furthermore, a width b₉ of the bridge section 37 is slightly less than the width b₄ between the strips 14 and the width b₁ of the longitudinal groove 8. A diameter d₄ of the rounded off sides of the borehole component 33 is slightly larger than the diameter d₃ between the wings 22, and corresponds to approximately the diameter d₂ of the circular recesses 16, the diameter d₁ of the circular recesses 11 as well as the width b₃ of the recess 13 and the width b₂ between the sliding channels 10.

When viewed from the top, the circular borehole component 34 exhibits throughout the diameter d₄, which, as already stated above, is slightly larger than the diameter d₃ between the wings 22, but corresponds to approximately the diameter d₂ of the circular recesses 16, the diameter d₁ of the circular recesses 11 as well as the width b₃ of the recess 13 and the width b₂ between the sliding channels 10.

A fastening element 24 having a threaded section 35 is inserted securely or detachably into approximately the center of the bridge section 37. This fastening element exhibits a screw head 32 and a shaft section 36 between the screw head 32 and the threaded section 35. The shaft section 36 runs through the recess 23, and said shaft section has a rotating knob 25.

The rotating knob 25, which is depicted in FIG. 5 in a sectional view, exhibits an upper section 26, which passes at least partially through the circular borehole component 34. The shape of this upper section matches the circular recess 16, but also the circular recess 11. That is, a diameter d₅ of the rotating knob 25 corresponds to approximately the diameter d₃ between the wings 22, but is slightly less than the diameter d₄ of the circular borehole component 34, the diameter d₂ of the circular recesses 16, the diameter d₁ of the circular recesses 11 as well as the width b₃ of the recess 13 and the width b₂ between the sliding channels 10.

The shape of the bottom section 27 of the rotating knob 25 matches the rectangular borehole component 33, which is rounded off on two opposite sides. That is, a width b₁₀ of the bottom section 27 is slightly less than the width b₆ of the straight sides of the borehole component 33 as well as the width b₇ of a spacer 39 between the circular recesses 11 and the width b₈ of a spacer 40 between the circular recesses 16.

A length l₂ of the bottom section 27 is slightly less than the diameter d₄ of the opposite, rounded off sides of the borehole component 33, the diameter d₃ between the wings 22, the diameter d₂ of the circular recesses 16, the diameter d₁ of the circular recesses 11 as well as the width b₃ of the recess 13 and the width b₂ between the sliding channels 10.

However, the length l₂ of the bottom section 27 is larger than the width b₆ of the straight sides of the borehole component 33, the length l₁ of the bridge section 37 as well as the width b₇ of a spacer 39 between the circular recesses 11 and the width b₈ of a spacer 40 between the circular recesses 16.

Mounted on a top side 28 of the upper section 26 of the rotating knob 25 is a direction indicator 29, which runs parallel to the bottom section 27 and, thus, reproduces the position of the bottom section 27.

The rotating knob 25 is configured so as to be displaceable along the shaft section 36. Therefore, a borehole 30 runs approximately through the middle of the rotating knob 25. The shaft section 36 passes through said borehole. A spring 31 is provided around the shaft section 36. The spring 31 is braced on its one side against the underside of the screw head 32 of the screw bolt 24. On the opposite side the spring 31 is braced against the bottom floor of the section 27.

The working principle of the present invention is as follows.

The lashing point 2 had already been fastened beforehand in a floor (not illustrated in detail) of a helicopter or the like. Then the connecting element 3 is mounted on the rim area 9 of the lashing point 2 in the direction of the arrows 41 and 42, shown in FIG. 1, and is slid until the guide rail 20 on the underside 19 of the connecting element 3—that is, the rail track 21, the wings 22 and the bridge section 37 of the guide rail 20—engages with the longitudinal groove 8, the circular recesses 11 and the spacer 39 of the lashing point 2. As soon as this happens, the connecting element 3 slides into the longitudinal groove 8. The underside 19 of the connecting element 3 rests on the rim area 9 of the lashing point 2.

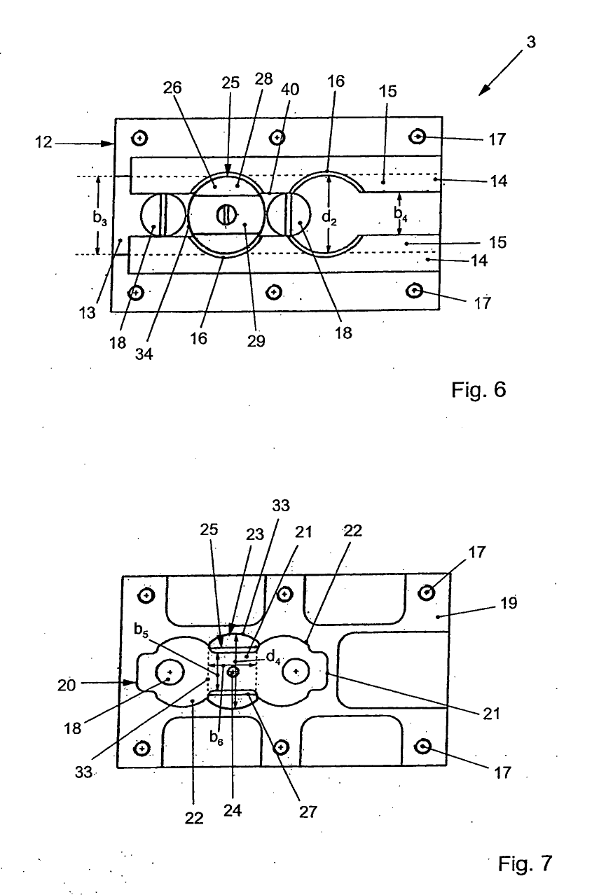

In this position the rotating knob 25 of the connecting element 3 is still in the unlocked state (see FIGS. 6 and 7). That is, since the length l₂ of the bottom section is greater than the width b₆ of the straight sides of the borehole component 33, the bottom section 27 of the rotating knob 25 lies towards the end on the step 43, formed by the two borehole components 33 and 34, in the recess 23. Therefore, the spring 31, enveloping the shaft section 36, is in a prestressed state.

In order to lock the connecting element 3 in the longitudinal groove 8 of the lashing point 2, the connecting element 3 is first moved to the left or to the right. In this way the wings 22 of the guide rail 20 move into the sliding channels 10 of the longitudinal groove 8 and cannot be removed from the sliding channels 10, because the diameter d₃ of the wings 22 is greater than the width b₁ of the longitudinal groove 8.

Then the rotating knob 25 is rotated preferably about 90° out of its starting position, shown in FIGS. 6 and 7, until it assumes its position, according to FIGS. 3 and 4. This rotation of the rotating knob 25 allows the bottom section 27 to move completely into the open area of the rectangular borehole component 33. The spring 31, which was beforehand in a prestressed state, can now relax and pushes the rotating knob 25 downwards, so that the bottom section 27 is accommodated by the rectangular borehole component 33, and the upper section 26 is accommodated by the circular borehole component 34.

As a result, the top side 28 of the rotating knob 25 moves into the plane of the recess 13. The bottom section 27 of the rotating knob 25 fills the cavity below the bridge section 37 and simultaneously one of the circular recesses 11, because a length l₂ of the bottom section 27 is slightly less than the diameter d₁ of the circular recesses 11. At this stage it is no longer possible to displace the connecting element 3.

DR. PETER WEISS; A. BRECHT, GRAD.
ENG.; & PETRA ARAT, GRAD. FORESTRY
Patent Attorneys
European Patent Attorneys
File Number: G 1277/PCT
Date: Nov. 16, 2005
AR/HE
List of Reference Numerals

| | |
|---|---|
| 1 | device |
| 2 | lashing point |
| 3 | connecting element |
| 4 | rail arm |
| 5 | rail arm |
| 6 | base plate |
| 7 | surface |
| 8 | longitudinal groove |
| 9 | rim area |
| 10 | sliding channels |
| 11 | circular recess |
| 12 | base plate |
| 13 | recess |
| 14 | strip |
| 15 | sliding channel area |
| 16 | circular recess |
| 17 | boreholes |
| 18 | bolt |
| 19 | underside |
| 20 | guide rail |
| 21 | rail track |
| 22 | wing |
| 23 | recess |
| 24 | fastening element |
| 25 | rotating knob |
| 26 | upper section |
| 27 | bottom section |
| 28 | top side |
| 29 | direction indicator |
| 30 | borehole |
| 31 | spring |
| 32 | screw head |
| 33 | rectangular borehole component |
| 34 | circular borehole component |
| 35 | threaded section |
| 36 | shaft section |
| 37 | bridge section |
| 38 | material recess |
| 39 | spacer |
| 40 | spacer |
| 41 | arrow |
| 42 | arrow |
| 43 | step |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| l₁ | length |
| l₂ | length |
| b₁ | width |
| b₂ | width |
| b₃ | width |
| b₄ | width |
| b₅ | width |
| b₆ | width |
| b₇ | width |
| b₈ | width |
| b₉ | width |
| b₁₀ | width |
| d₁ | diameter |
| d₂ | diameter |
| d₃ | diameter |
| d₄ | diameter |
| d₅ | diameter |

1-44. (canceled)

45. A device for immobilizing an object comprising:
a base plate;
a recess, wherein the recess is disposed to extend along a longitudinal direction of the base plate;
a pair of strips, wherein the strips are disposed to hem within the recess thereby forming a sliding channel;
a pair of circular recesses, wherein the circular recesses are contained within the pair of strips; and
a guide rail, wherein the guide rail is attached to the underside of the base plate.

46. The device of claim 45, wherein the guide rail further comprises a rail track, whereby the width of the rail track isles than the width between the pair of strips.

47. The device of claim 45, wherein the guide rail further includes a plurality of wings extending outwardly from the guide rail.

48. The device of claim 46, wherein the rail track further includes a bridge section, whereby the bridge section exhibits a recess.

49. The device of claim 48, wherein the recess contained within the bridge section extends over a recess in the base plate located between the wings.

50. The device of claim 49, wherein the recess in the base plate located between the wings exhibits a borehole component.

51. The device of claim 50, wherein a fastening element is detachably inserted within the bridge section.

52. The device of claim 51, wherein the fastening element further comprises:
a threaded section;
a screw head located at one end of the threaded section; and
a shaft section, wherein the shaft section is located between the screw head and the threaded section.

53. The device of claim 53, wherein the shaft section of the fastening element further includes a rotating knob.

54. The device of claim 54, wherein the rotating knob further includes an upper section, whereby the upper section of the rotating knob extends through the borehole component.

55. The device of claim 55, wherein the upper section of the rotating knob further includes a top side having a direction indicator.

56. The device of claim 53, wherein the rotating knob further includes a borehole, whereby the borehole is disposed to extend through substantially the middle of the knob.

57. The device of claim 52, wherein the shaft section of the fastening element further includes a spring.

58. The device of claim 45, wherein the base plate further includes a plurality of threaded boreholes, whereby the boreholes are disposed along the edges of the base plate.

59. The device of claim 45, wherein a pair of bolts is utilized to secure the guide rail to the base plate, whereby the bolts extend through the recess of the base plate.

60. The device of claim 45, wherein the device is receivable into a lashing point comprising:
a base plate;
a pair of rail arms, wherein the rail arms extend outwardly from the base plate;
a longitudinal groove, wherein the longitudinal groove extends along the base plate;
a raised rim, wherein the raised rim extends along the longitudinal groove, whereby the raised rim creates a sliding channel.

61. The device of claim 60, wherein the device is utilized to fasten an object within a passenger compartment.

62. The device of claim 61, wherein the passenger compartment is located within a helicopter.
